(19) United States
(12) Patent Application Publication
(10) Pub. No.: US 2015/0019776 A1
(43) Pub. Date: Jan. 15, 2015

(54) SELECTIVE CHANGE OF PENDING TRANSACTION URGENCY

(71) Applicant: QUALCOMM TECHNOLOGIES, INC., San Diego, CA (US)

(72) Inventors: Jean-Jacques Lecler, Sunnyvale, CA (US); Jonah Proujansky-Bell, Alviso, CA (US); Philippe Boucard, Le Chesnay France (FR)

(73) Assignees: QUALCOMM TECHNOLOGIES, INC., San Diego, CA (US); ARTERIS SAS, Guyancourt (FR)

(21) Appl. No.: 13/941,537

(22) Filed: Jul. 14, 2013

(51) Int. Cl. G06F 13/362

(52) U.S. Cl. CPC G06F 13/362
USPC 710/110

(57) ABSTRACT

The present invention provides a transaction interface to be used between semiconductor intellectual property cores. The urgency attribute of pending transactions can be changed by a special type of transaction at the interface. The urgency can be incremented, raised to at least an indicated value, or changed to a value as specified. For an interface with multiple pending transactions, a mask can be used to indicate one or more IDs, the transactions of which should be changed.

### FIELD OF THE INVENTION

The disclosed invention relates to semiconductors systems and, more specifically, to an interface protocol implemented at the transaction interface between intellectual property modules within semiconductor chips.

### BACKGROUND

Chip designs, particularly system-on-chip (SoC) designs, include semiconductor intellectual properties (IPs). IPs are connected together through transaction interfaces that enable transferring data. This is primarily done with read and write transaction requests. A transaction interface connects a master to a slave. The master IP sends requests to the slave IP and the slave IP sends responses to the master IP. A transaction, during the time between the master sending the request and the slave sending the response, is referred to as being pending. There are numerous transaction interface protocols in the industry. Advanced Microcontroller Bus Architecture (AMBA) eXtensible Interface (AXI) is one common one. Open Cores Protocol (OCP) is another.

Some protocols require that a master wait for a response from its slave before sending another request, such that only one transaction is pending at a time. Other protocols allow a master to issue many requests while waiting for its slave to give the corresponding responses. Some such protocols allow a response to a later request to be sent before a response to an earlier request. Such protocols generally call for a transaction identifier number associated with each transaction and require that all responses to request with the same identifier are sent in the same order as their requests.

Some protocols call for an urgency value to be associated with each transaction. The urgency of pending transactions is used by the slave to determine the priority with which to service each. Sometimes, after a master has sent a transaction request with a particular level of urgency it might determine that it wants the slave to service the transaction with a different level of urgency. Therefore what is needed is a protocol for transactions between IPs that allows the urgency of pending transactions to be changed.

Some protocols have a back-pressure mechanism, where the slave may temporarily delay its acceptance of a request from the master, and/or conversely where the master may delay its acceptance of a response coming from the slave. When the slave exercises back-pressure, it stops the forward progress of the request channel, delaying not just the acceptance of the request being presented by the master, but also the presentation by the master of further requests.

Some protocols embed a forward-pressure mechanism, where the master may signal to the slave the importance for the request channel to make forward progress. This forward-pressure signal is typically used by a slave entity with multiple downstream slave interfaces. The entity decides which of the downstream slave interfaces will accept a request and, thus, make forward progress. In a protocol where urgency is used, a reason for the master to force the forward progress of the request channel, is to transfer an urgent request. Another forward-pressure mechanism may be used by the slave to signal to the master the importance for the response channel to make forward progress. Therefore, what is needed is a system and method that allows a protocol to increment the urgency of the pending transaction when exchanging data between IPs.

### SUMMARY OF THE INVENTION

The disclosed invention provides for a protocol for IPs to exchange data through a transaction interface. The protocol allows for the urgency of pending transactions to be incremented, raised to at least a specified level, or set to a specified level. Furthermore, the protocol allows the master to effect its change to the urgency of transactions to a subset of all pending transactions. The subset is generally defined by a mask.

Many types of IPs can act as slaves of a transaction interface. One type of IP of particular interest is a dynamic random access memory (DRAM) controller. A DRAM controller is often the primary limiter to the performance of a SoC. Therefore, great care goes into the design of DRAM controllers. DRAM controllers are best able to take advantage of the properties of DRAM memory chips when they have freedom to choose from multiple pending transactions needing service. Because of this, DRAM controllers tend to have large buffers of pending transactions to service. Depending on the other pending transactions, any particular one might wait for a very long time. Urgency values guide the choices made by a DRAM controller for the benefit of ensuring that some requests are serviced more quickly. If the master IP that requested a pending transaction enters a state in which it needs a response quickly, it uses the disclosed protocol to promote or increase one or more of its pending transactions. By so doing, the DRAM controller will service the one or more pending transactions more quickly.

Urgency values constrain the choices made by a DRAM controller for the benefit of ensuring that some requests are serviced more quickly, despite a degradation of the responsiveness of the DRAM controller to other requests. If a master IP has raised the urgency of one or more pending transactions as described above and it enters a state in which it no longer needs one or more transactions to be serviced as quickly (perhaps because some pending transactions were already serviced), then it uses the disclosed protocol to demote or set a new lower urgency for the one or more transactions. Urgency demotion avoids detriment to other IPs and, by restoring freedom to a DRAM controller, improves the performance of the DRAM memory.

Another interesting type of IP that can act as a slave of a transaction interface is a packet-based network-on-chip (NoC). A NoC is a slave to an “upstream” initiator IP and is a master to a “downstream” target IP. A NoC generally transfers requests as quickly as possible between initiators and targets. Slaves can take any length of time to service requests. If an initiator requests a change in urgency according to the disclosed invention on the upstream slave interface then the NoC must send an urgency packet to the downstream master interface of the target. Furthermore, where backpressure prevents the forward progress of packets within the NoC, an urgency packet causes the assertion of forward pressure. Forward pressure affects arbitration within the network. Arbitration, and pressure, apply to both requests and responses within a NoC.

### BRIEF DESCRIPTION OF THE DRAWINGS

FIG. 1 illustrates the signals of a transaction interface according to the various aspects of the present invention.

### DETAILED DESCRIPTION

The various aspects of the present invention may be implemented in software, hardware, application logic, or a combination of software, hardware, and application logic. The software, application logic and/or hardware may reside on a server, an electronic device, or a service. If desired, part of the software, application logic and/or hardware may reside on an electronic device, part of the software, application logic and/or hardware may reside on a server.

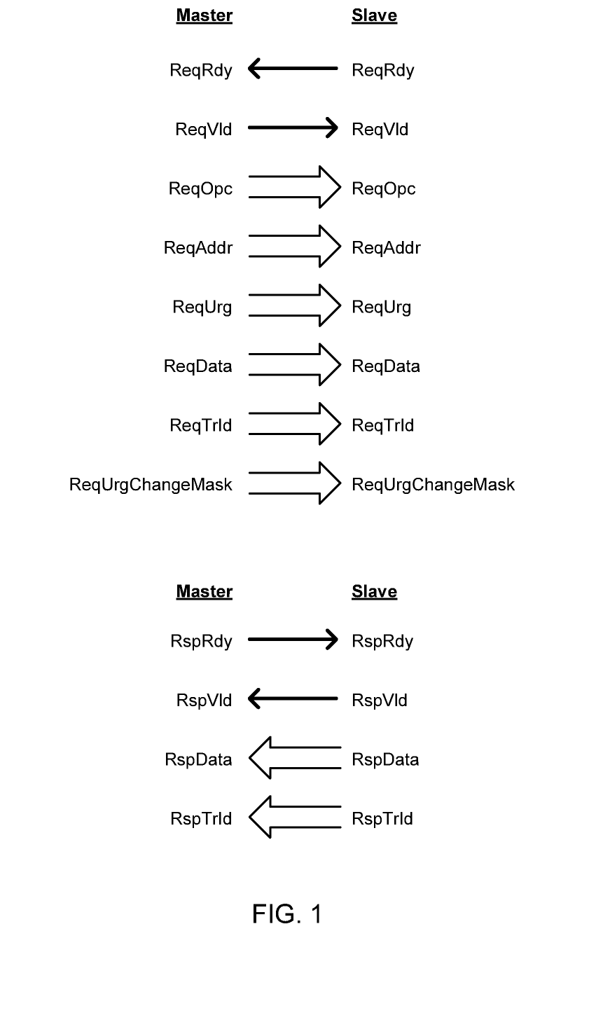

Referring now to FIG. 1, a transaction interface according to the present invention is shown. The interface includes a request channel and a response channel. Request channel signals are named with the prefix “Req” and response channel signals are named with the prefix “Rsp”. A transaction is initiated when the slave asserts ReqRdy and the master asserts ReqVld in the same clock cycle. The opcode (type of transaction) is indicated by the master with the ReqOpc signal. Conventionally, read and write are possible opcodes. According to an aspect of the present invention, an urgency change is another type of opcode. The address of the transaction is indicated by the master with the ReqAddr signal. The urgency of the transaction is indicated by the master with the ReqUrg signal.

According to an aspect of an embodiment of the present invention, the master uses the ReqUrg signal to indicate a new urgency value for the slave to apply to zero or more pending transactions. The data to be written, if the transaction has a write opcode, is indicated by the master with the ReqData signal. According to an aspect of the present invention, a transaction identifier (ID) is indicated for each transaction request by the master with the ReqTrld signal. In accordance with some aspects, the transaction ID signal is unique for each transaction.

According to aspects of the present invention shown in FIG. 1, the interface supports more than one pending transaction and the master indicates, with the ReqUrgChangeMask signal, for an urgency change operation, which pending transaction's urgency to change. The ReqUrgChangeMask signal has one bit for each possible value of TrID. The urgency of all transactions pending in the slave IP with a TrID value matching the equivalent bit asserted in the ReqUrgChangeMask signal is changed.

In accordance with some aspects of the present invention, the ReqUrgChangeMask signal is not present and an urgency change operation causes the slave to changes the urgency of all pending transactions. In accordance with some aspects of the present invention, the ReqUrgChangeMask signal is not present and the ReqAddress signal represents the value otherwise presented ReqUrgChangeMask. In other aspects of the present invention, the ReqUrgChangeMask signal is not present and the Req Data signal represents the value otherwise presented ReqUrgChangeMask.

A transaction is completed by a response on the response channel. A response occurs when the master asserts RspRdy and the slave asserts RspVld in the same cycle. The read data, if the transaction had a read opcode, is indicated by the slave with the RspData signal. The transaction identifier is indicated for each transaction response by the slave with the RspTrld signal.

Whereas a transaction interface, according to the present invention, can cause a set of pending transactions to change urgency, the change in urgency is most beneficial if it causes transactions blocked within an IP, such as a NoC, to make forward progress. This is done with a forward-going pressure signal. Where pressure is used within a master IP and a slave IP, it is useful to have a sideband pressure signal. This is distinguished in that it is out-of-band (not associated with any particular transaction) whereas the mechanism for promoting the urgency of transactions is in-band (associated to one or more particular transactions).

According to various aspects of the present invention, the request to change the urgency of a set of pending transactions is carried on the request channel and, thus, subject to slave back-pressure. According to another aspect of the present invention, the master may use a forward-pressure signal on the request channel to accelerate the notification to the slave of such a change of urgency, in the same way it would have done to accelerate the notification to the slave of an urgent request.

### Recitation of variations

One aspect of the present invention, as exemplified in one embodiment, discloses a transaction request with an urgency change opcode that causes an incrementing of the urgency of all transactions pending for that transaction interface. Such a transaction request receives no response.

In accordance with another aspect, a transaction request with an urgency change opcode causes the urgency of all transactions pending for that transaction interface to be assigned the value of ReqUrg. Such a transaction request receives no response.

In accordance with another aspect, a transaction request with an urgency change opcode causes the urgency of all transactions pending for that transaction interface to be assigned the value of ReqUrg, but only if the value of ReqUrg is greater than the existing urgency value. Such a transaction request receives no response.

In accordance with another aspect, an interface supports 32 pending transactions, each with a transaction ID value and an urgency value. A bit of the address signal corresponds to each transaction ID value. Address bit 0 corresponds to transaction ID with binary value 00000. Address bit 1 corresponds to transaction ID with binary value 00001. Address bit 2 corresponds to binary transaction ID 00010, etc., such that address bit 31 corresponds to transaction ID with binary value 11111. A transaction request with an urgency change opcode causes the urgency of all transactions pending for that transaction interface to be assigned the value of ReqUrg. Such a transaction request receives no response.

In accordance with another aspect, an interface supports 32 pending transactions, each with a transaction ID value and an urgency value. A bit of the address signal corresponds to each transaction ID value as described above. Each pending transaction has a unique transaction ID value. A transaction request with an urgency change opcode causes the urgency of all transactions pending for that transaction interface to be assigned the value of ReqUrg. Such a transaction request receives no response.

In accordance with another aspect, an interface supports 32 pending transactions, each with a transaction ID value and an urgency value. A bit of the address signal corresponds to each transaction ID value as described above. Each pending transaction has a unique transaction ID value. A transaction request with an urgency change opcode causes the urgency of all transactions pending for that transaction interface to be assigned the value of ReqUrg. Such a transaction receives a response after the slave IP has processed the change of urgency.

In accordance with another aspect, an interface supports 16 pending transactions, each with a transaction ID value and an urgency value. A ReqUrgChangeMask signal has 16 bits. Each corresponds to a transaction ID value as described above. Each pending transaction has a unique transaction ID value. A transaction request with an urgency change opcode causes the urgency of all transactions pending for that transaction interface to be assigned the value of ReqUrg. Such a transaction receives a response after the slave IP has processed the change of urgency.

In accordance with another aspect, an interface comprises a sideband signal indicating a pressure level. Pressure is used within the slave IP to force forward progress of queued transactions.

As will be apparent to those of skill in the art upon reading this disclosure, each of the aspects described and illustrated herein has discrete components and features which may be readily separated from or combined with the features and aspects to form embodiments, without departing from the scope or spirit of the present invention. Any recited method can be carried out in the order of events recited or in any other order which is logically possible.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein.

In accordance with the teaching of the present invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that includes a series of instructions, such as computer readable program steps or code encoded therein. In certain aspects of the present invention, the non-transitory computer readable medium includes one or more data repositories. Thus, in certain embodiments that are in accordance with any aspect of the present invention, computer readable program code (or code) is encoded in a non-transitory computer readable medium of the computing device. The processor, in turn, executes the computer readable program code to create or amend an existing computer-aided design using a tool. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the present invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement either a control system either in logic or via a set of commands executed by a soft-processor.

Accordingly, the preceding merely illustrates the various aspects and principles of the present invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the various aspects discussed and described herein. Rather, the scope and spirit of present invention is embodied by the appended claims.

What is claimed is:

1. A semiconductor intellectual property module comprising a transaction interface, the transaction interface comprising an operation code signal capable of indicating an operation that changes an urgency of zero or more pending transactions.

2. A semiconductor intellectual property module according to claim 1 wherein the operation increments the urgency by one level.

3. A semiconductor intellectual property module according to claim 1 wherein an urgency transaction comprises a request and a response.

4. A semiconductor intellectual property module according to claim 1 wherein the transaction interface further comprises a forward-pressure mechanism on a request channel.

5. A semiconductor intellectual property module according to claim 1 wherein the transaction interface further comprises a forward-pressure mechanism on a response channel.

6. A semiconductor intellectual property module according to claim 1 wherein the transaction interface further comprises an urgency signal whereby the operation sets the urgency to a value indicated by the urgency signal.

7. A semiconductor intellectual property module according to claim 6 wherein the operation sets the urgency only if the value indicated by the urgency signal is greater than the urgency.

8. A semiconductor intellectual property module according to claim 1 with logic to support more than one pending transactions, the transaction interface further comprising:
a transaction identifier signal; and
a transaction mask signal,
wherein, each pending transaction has an associated identifier and the zero or more pending transactions are ones having an identifier that correspond to the value indicated by the transaction mask signal.

9. A semiconductor intellectual property module according to claim 8 wherein each pending transaction has a unique identifier.

10. A semiconductor intellectual property module according to claim 8 wherein the transaction mask signal is the address signal.

11. A semiconductor intellectual property module according to claim 8 wherein the transaction mask signal is the request data signal.

12. A semiconductor intellectual property module according to claim 8 wherein the transaction interface further comprises an urgency signal whereby the operation sets the urgency to a value indicated by the urgency signal.

13. A semiconductor intellectual property module according to claim 12 wherein an urgency change operation with an urgency level lower than a pending transaction causes the urgency of the pending transaction to decrease.
